(19) United States
(12) Patent Application Publication
(10) Pub. No.: US 2019/0020831 A1
(43) Pub. Date: Jan. 17, 2019

(54) NEAR-INFRARED THERMAL-IMAGING CAMERA, AND SYSTEM USING THE NEAR-INFRARED THERMAL-IMAGING CAMERA FOR OBSERVING A LIVING TARGET

(71) Applicants: Chi-Sheng HSIEH, Hsinchu City (TW); Pao-Chyuan CHEN, Zhubei City (TW)

(72) Inventors: Chi-Sheng HSIEH, Hsinchu City (TW); Pao-Chyuan CHEN, Zhubei City (TW)

(21) Appl. No.: 15/923,824

(22) Filed: Mar. 16, 2018

(30) Foreign Application Priority Data
Jul. 12, 2017 (TW) 106123267

(51) Int. Cl. H04N 5/33; H04N 5/225; G06T 5/50; G06T 5/00; G06K 9/20

(52) U.S. Cl. CPC H04N 5/332; H04N 5/2256; H04N 5/2258; G06K 9/6288; G06T 5/003; G06K 9/2018; G06T 2207/20221; G06T 5/50

(57) ABSTRACT

A near-infrared thermal-imaging camera includes a first lens unit for generating a first image based on far infrared, a second lens unit for generating a second image based on near-infrared, a near infrared source unit to project NIR light toward an object in a target direction, and a processor to perform image fusion on the first and second images to generate a fusion image.

### CROSS-REFERENCE TO RELATED APPLICATION

This application claims priority of Taiwanese Patent Application No. 106123267, filed on Jul. 12, 2017.

### FIELD

The disclosure relates to a camera, and more particularly to a near-infrared thermal-imaging camera.

### BACKGROUND

Objects with temperatures over 0 K (zero kelvins) will emit invisible electromagnetic radiations (heat radiations) in the far infrared (FIR) range (roughly between 8 μm and 14 μm in terms of wavelength), and the intensity of the FIR radiation is a function of and positively correlated to the temperature of the object. Therefore, conventional thermography cameras use a focal plane array (FPA) that is sensitive in a spectrum of far infrared in cooperation with a lens unit to convert radiation from the objects into electric signals, followed by using a processor module to calculate temperature values corresponding to the electric signals, and perform image processing based on the calculated temperature values to generate, on a screen, a visible FIR thermal image (thermography) in which different pseudo colors are used to represent different temperature values. Accordingly, even if an object, which has a relatively high temperature (e.g., an animal), is hidden in a dark area, it can still be easily seen in the FIR thermal images captured by the infrared-thermography cameras.

However, the objects shown in such an FIR thermal image are usually vague since the FIR thermal image only shows differences in temperature, and details of the object, like edges of the objects, cannot be clearly shown therein.

To improve image quality, as shown in FIG. 1, some companies, such as FLIR systems Inc., Fluke Corporation, etc., proposed a thermographic camera 100 with a dual-lens structure, like FLIR ONE®, that includes, in addition to a lens unit 11 and an FPA 13 which are included in the conventional thermography cameras, another lens unit 12 and an image sensor 14 (e.g., a CCD sensor, a CMOS sensor, etc.) that cooperatively capture visible light (VIS, approximately between 0.38 μm and 0.78 μm, or between 0.4 μm and 0.8 μm in terms of wavelength) to generate a visible-light image, followed by performing image fusion (a conventional technique to combine images of the same scene, which are captured in different conditions, such as under different capturing modes, at different capturing times, etc., so as to generate a fusion image that contains desired information which may originally be dispersed amongst different captured images) on the FIR thermal image and the visible-light image. Accordingly, details of the scene being captured, which may be acquired from the visible-light image, can be added to the FIR thermal image to form the fusion image, improving the image quality. However, near infrared, which ranges generally between 0.8 μm and 1.0 μm in terms of wavelength, may also pass through the lens unit 12. If near infrared reaches the image sensor 14, the resultant image may become reddish. In order to approach the true colors (i.e., the colors as perceived by human eyes) of the scene in the resultant image when such conventional dual-lens camera is used as an ordinary camera (i.e., merely acquiring the visible-light image), an infrared cut filter (ICF) 19 is placed between the lens unit 12 and the image sensor 14 for filtering out the near infrared in order to ensure image quality.

Further referring to FIG. 2, the electromagnetic waves provided by a to-be-captured object are exemplified to have a spectrum 21, which may result from reflection of sunlight that passes through the infrared atmospheric window, and which illustrates intensity distribution of the electromagnetic waves in terms of wavelength, where a wavelength range of between 1 μm and 8 μm (e.g., a gray colored part in the spectrum 21) is omitted since such a range is irrelevant in the context of this disclosure, and wavelength ranges of “VIS+NIR” (VIS: visible light; NIR: near infrared) and “FIR” are not plotted in the same scale for convenience of plotting the drawing. The first lens unit 11 may filter out electromagnetic waves that are outside of the FIR spectrum, so the electromagnetic waves are exemplified to have the spectrum 22 after passing through the first lens unit 11. The second lens unit 12 may filter out electromagnetic waves that are outside of both of the VIS spectrum and the NIR spectrum, so the electromagnetic waves are exemplified to have the spectrum 23 after passing through the second lens unit 12. The ICF 19 receives the electromagnetic waves that pass through the second lens unit 12, and filters out the electromagnetic waves that are in the NIR spectrum, so that the electromagnetic waves passing through the ICF 19 are exemplified to have the spectrum 24.

However, when such conventional dual-lens thermographic camera 100 is used in a completely dark environment or a target to be captured by the camera 100 is covered by an opaque object, the image sensor 14 will become useless, and the image thus captured may only include the FIR thermal image part, and is unable to show details of the target.

FIGS. 3A through 3C show images captured using the conventional thermographic camera 100, and the to-be-captured object includes an empty first cup on the left side and a second cup filled with hot water on the right side. FIG. 3A shows nine fusion images (including both the visible-light image part and the thermal image part) that are generated according to different pseudo color modes P1-P9, from which a user can select a desired representation. In FIG. 3B, the FIR thermal image depicted in FIG. 3A under the pseudo color mode P1 is shown in bigger scale. It can be seen in FIG. 3B that a thermal image P1B of the first cup has a color similar to that of a thermal image P1A of the background and is thus unclear because a temperature of the empty first cup is close to room temperature. On the other hand, a thermal image P1C of the second cup has a color quite different from that of the thermal image P1B. By merely comparing the thermal images P1B and P1C, a user can only know that the two cups are of different temperatures, but cannot know what are inside the two cups. FIG. 3C shows the FIR thermal image depicted in FIG. 3A under the pseudo color mode P5, enlarged. In FIG. 3C, the thermal image P5B of the first cup is clearer in comparison to the thermal image P1B in FIG. 3B and the thermal image P5B1 of a handle of the first cup is quite distinguishable from the thermal image P5B2 of a cup body of the first cup because of different pseudo color combinations. In each of the FIR thermal images shown in FIG. 3A, it can be seen that the two cups have difference in temperature; however, the reason that induces such difference cannot be clearly identified from the images, and the edge of a bottom of the second cup (e.g., the thermal image P5C1 in FIG. 3C) is blurry because the heat of the hot water may be conducted to, for example, a tabletop on which the second cup is placed through the bottom of the second cup.

### SUMMARY

Therefore, an object of the disclosure is to provide a near-infrared thermal-imaging camera that can alleviate at least one of the drawbacks of the prior art.

According to the disclosure, the near-infrared thermal-imaging camera includes a first lens unit, a second lens unit, a near infrared (NIR) source unit and a processor. The first lens unit is disposed to receive electromagnetic waves from a target scene, and allows passage of at least a portion of the electromagnetic waves received thereby. The at least a portion of the electromagnetic waves passing through the first lens unit represents a first image. The second lens unit is disposed to receive electromagnetic waves substantially from the target scene, and allows passage of at least a portion of the electromagnetic waves received thereby that falls within a spectrum of near infrared (NIR), which ranges between 0.4 μm and 1 μm in terms of wavelength. The at least a portion of the electromagnetic waves passing through the second lens unit represents a second image. The electromagnetic waves passing through the first lens unit and the electromagnetic waves pass through the second lens unit are independent from each other. The NIR source unit is configured to project NIR light that has a wavelength falling within the spectrum of near infrared toward the target scene, such that the NIR light projected thereby is reflected to the second lens unit by an object disposed in the target scene. The processor is configured to perform image fusion on the first and second images to generate a fusion image.

Another object of the disclosure is to provide a system that uses the near-infrared thermal-imaging camera of this disclosure to observe a living target.

According to the disclosure, the system includes the near-infrared thermal-imaging camera of this disclosure and an opaque separator. The near-infrared thermal-imaging camera is disposed such that the living target is part of the target scene with respect to the near-infrared thermal-imaging camera. The opaque separator allows passage of electromagnetic waves falling within the spectrum of near infrared, and is to be disposed between the near-infrared thermal-imaging camera and the living target such that electromagnetic waves falling within the spectrum of near infrared and coming from the living target are received by the second lens unit of the near-infrared thermal-imaging camera after passing through the opaque separator.

### BRIEF DESCRIPTION OF THE DRAWINGS

Other features and advantages of the disclosure will become apparent in the following detailed description of the embodiment(s) with reference to the accompanying drawings, of which:

FIG. 1 is a block diagram illustrating a conventional thermographic camera;

FIG. 2 is a schematic diagram illustrating variations in spectrum of electromagnetic waves that enter the conventional thermographic camera;

FIGS. 3A-3C include multiple FIR thermal images captured by the conventional thermographic camera;

FIG. 4 is a block diagram illustrating an embodiment of a near infrared thermal-imaging camera according to this disclosure;

FIGS. 5A-5C are perspective views illustrating the embodiment;

FIGS. 6A and 6B are images illustrating disassembly of the conventional thermographic camera;

FIGS. 7A-7F are schematic diagrams illustrating an exemplary application of the embodiment;

FIG. 8 is a schematic diagram illustrating operation of the embodiment;

FIGS. 9A-9E are schematic diagrams illustrating an implementation of an opaque separator that cooperates with the embodiment to form a system for secretly observing a living target; and

FIGS. 10A-10F are images illustrating effects of the embodiment in comparison with the conventional thermographic camera.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

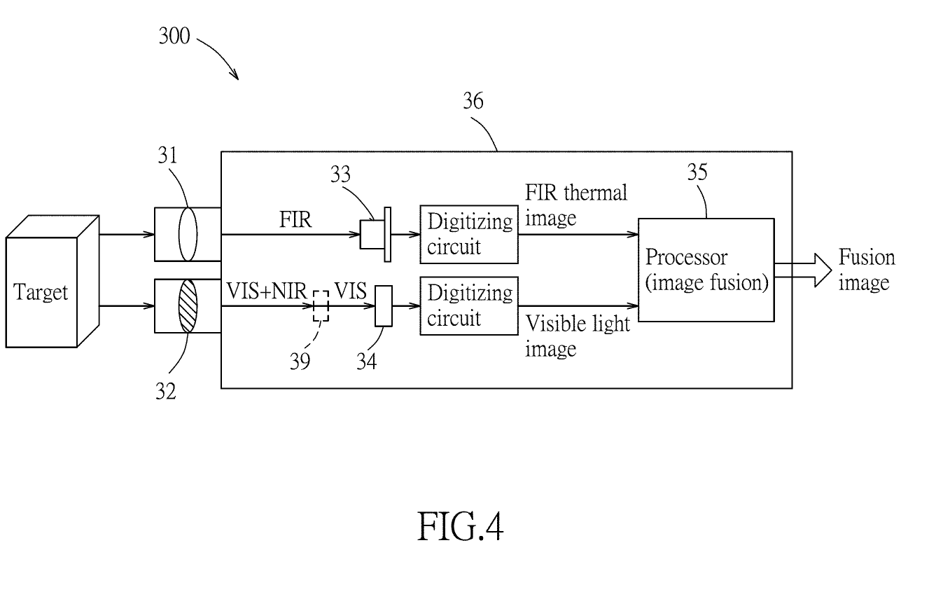

Referring to FIGS. 4 and 5A, the embodiment of the NIR thermal-imaging camera 300 according to this disclosure is shown to include a camera unit 300A and an NIR source unit 300B attached to the camera unit 300A. The camera unit 300A includes a first lens unit 31, a second lens unit 32, a focal plane array (FPA) 33, an image sensor 34, a processor 35, and a camera housing 36 to which the components 31-35 are mounted. In this embodiment, the NIR thermal-imaging camera 300 is made in a form of a module, which may be a peripheral device of a portable device like a smartphone, a tablet computer, a notebook computer, etc., and have an interface connector (e.g., a lighting or micro USB connector and the like) for connection to the portable device. However, this disclosure is not limited in this respect.

The first lens unit 31 faces toward a target scene (i.e., a scene at least including a to-be-captured target) to receive electromagnetic waves from the target scene, and allows passage of at least a portion of the electromagnetic waves received thereby that falls within a spectrum of far infrared (FIR) (e.g., ranging between 8 μm and 14 μm in terms of wavelength).

The second lens unit 32 is disposed adjacent to the first lens unit 31, and faces substantially toward the target scene (so that the scenes viewed through the first and second lens unit 31, 32 may be approximately the same) to receive electromagnetic waves substantially from the target scene, and allows passage of at least a portion of the electromagnetic waves received thereby that falls within a spectrum of near infrared (NIR) (e.g., ranging between 0.8 μm and 1 μm in terms of wavelength). In this embodiment, the second lens unit 32 allows passage of electromagnetic waves ranging between 0.4 μm and 1 μm in terms of wavelength, where the range between 0.4 μm and 0.8 μm corresponds to a spectrum of visible light (VIS) in terms of wavelength. The first and second lens units 31, 32 are separately disposed and do not overlap each other, so the electromagnetic waves passing through the first lens unit 31 and the electromagnetic waves passing through the second lens unit 32 are independent from each other (i.e., the electromagnetic waves passing through the first lens unit 31 do not subsequently pass through the second lens unit 32, and vice versa).

The focal plane array 33 is sensitive in the spectrum of far infrared, and is disposed on a focal plane of the first lens unit 31 to receive the electromagnetic waves passing through the first lens unit 31. The focal plane array 33 converts the electromagnetic waves received thereby into image signals that represent a first image (e.g., an FIR thermal image).

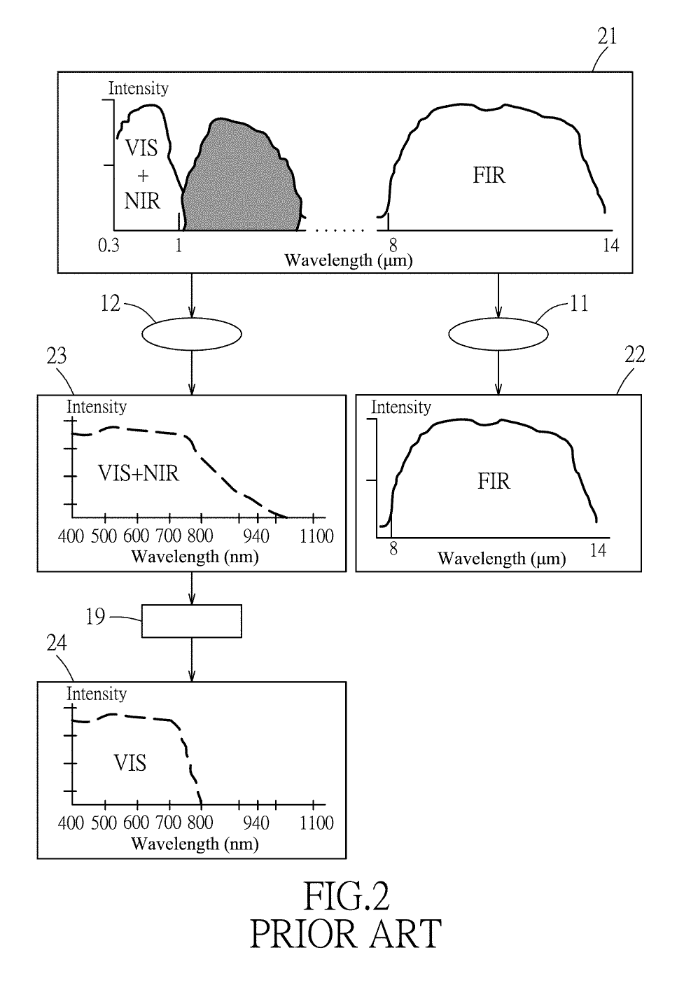

The image sensor 34 is sensitive in a spectrum of visible light (may be optional for this disclosure) and a spectrum of near infrared, and is disposed on a focal plane of the second lens unit 32 to receive the electromagnetic waves passing through the second lens unit 32. The image sensor 34 converts the electromagnetic waves received thereby into image signals that represent a second image. In this embodiment, a portion of the electromagnetic waves received by the image sensor 34 that falls within the spectrum of near infrared is substantially equal to the portion of the electromagnetic waves that falls within the spectrum of near infrared and that passes through the second lens unit 32 in terms of intensity, which means that between the second lens unit 32 and the image sensor 34, there is nothing, or at most only something that does not filter out the electromagnetic waves in the spectrum of near infrared (as denoted by the reference numeral 39), like an ordinary glass, BK-7 glass, etc. As a result, taking FIG. 2 as an example, the electromagnetic waves received by the image sensor 34 may have a spectrum similar to the spectrum 23. Accordingly, the image sensor 34 may receive near infrared light, which may originate from natural light (e.g., sunlight) and which is reflected by objects in front of the second lens unit 32 (i.e., within a field of view of the NIR thermal-imaging camera 300), thereby generating the image signals that represent the second image (e.g., an NIR image). The image sensor 34 may be, for example, a charge-coupled device (CCD) sensor, a complementary metal-oxide-semiconductor (CMOS) sensor, etc., but this disclosure is not limited in this respect.

The processor 35 is coupled to the focal plane array 33 and the image sensor 34 for receiving the image signals therefrom, and configured to perform image fusion on the first and second images to generate a fusion image. The fusion image may show a temperature distribution of the to-be-captured target resulting from FIR waves received by the focal plane array 33, with an appearance (especially for “edges” or “contour/outline” and “non-smooth parts”) of the to-be-captured target resulting from NIR waves received by the image sensor 34.

In this embodiment, the NIR source unit 300B includes an NIR source housing 301 having the same width and length as the camera housing 36, an infrared source module having a plurality of NIR light sources 302, a dimmer 303 for adjusting intensity of the NIR light emitted by the NIR light sources 302, and a battery (not shown) disposed within the NIR source housing 301 for providing electrical power required by the NIR light sources 302. The infrared source module may be an infrared light emitting diode (LED) module having a plurality of NIR LEDs that serve as the NIR light sources 302, and having a total power of between 1 watt and 5 watts. The dimmer 303 may be realized using a variable resistor or pulse width modulation (PWM). In this embodiment, when the intensity of the NIR light emitted by the NIR light sources 302 is adjusted to a level such that an intensity of the NIR light reflected by the to-be-captured target is higher than an intensity of the visible light reflected by the to-be-captured target, the NIR image would be included in the fusion image rather than the visible light image; and when the intensity of the NIR light reflected by the to-be-captured target is lower than the intensity of the visible light reflected by the to-be-captured target, the visible light image would be included in the fusion image rather than the NIR image. As a result, the NIR light and the visible light would not interfere with each other to adversely affect image quality of the fusion image.

It is noted that the near infrared from the sunlight may be relatively weak on cloudy days, rainy days, or in indoor places, so the appearance of the to-be-captured target in the fusion image, which results from the NIR waves received by the image sensor 34, may become relatively unclear in these situations. Accordingly, the NIR source unit 300B, which is attached to the camera unit 300A, may be used to project NIR light that has a wavelength falling within the spectrum of near infrared toward the target scene, such that the NIR light projected thereby is reflected to the second lens unit 32 by the to-be-captured target. In one embodiment, the wavelength of the NIR light projected by the NIR source unit 300B is between 0.8 mm and 1.0 mm. As a result, the NIR light emitted by the NIR source unit 300B may be reflected by the to-be-captured target and subsequently received by the second lens unit 32, thereby enhancing clarity of the appearance of the to-be-captured target in the fusion image.

The camera unit 300A may be configured to have a dimension suitable for being attached to a portable device 4 (e.g., a smartphone, a tablet computer, and the like), as shown in FIG. 5B. The camera unit 300A may further include a connector 37 (e.g., a male micro/lighting USB connector) mounted to the camera housing 36, so the data of the images captured by the camera unit 300A may be transmitted to the portable device 4 through the connector 37 that is connected to a corresponding connector 41 (e.g., a female micro/lighting USB connector, see FIG. 5C) of the portable device 4 for display on a screen 42 of the portable device 4. The camera unit 300A may further include an attaching component 38, which may be realized as one of a hook part and a loop part of a hook-and-loop fastener, a magnet, etc., for enhancing physical connection with the portable device 4 (provided with the other one of the hook part and the loop part of the hook-and-loop fastener, a ferromagnetic material that can be attracted by the magnet, etc., not shown). It is noted that the portable device 4 may require installation of an application 43 and a management tool 44 relating to the camera unit 300A for controlling operation of the camera unit 300A and enabling data transmission between the portable device 4 and the camera unit 300A.

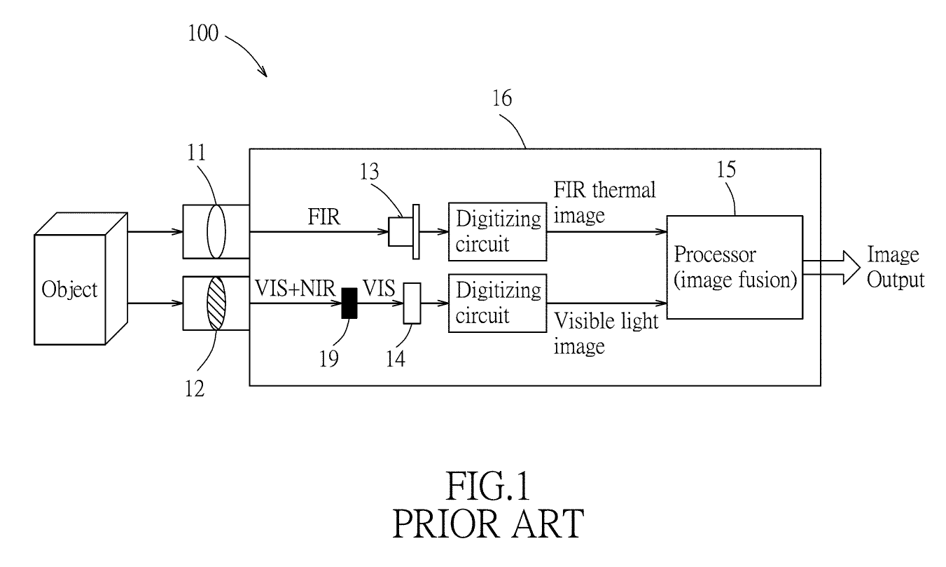

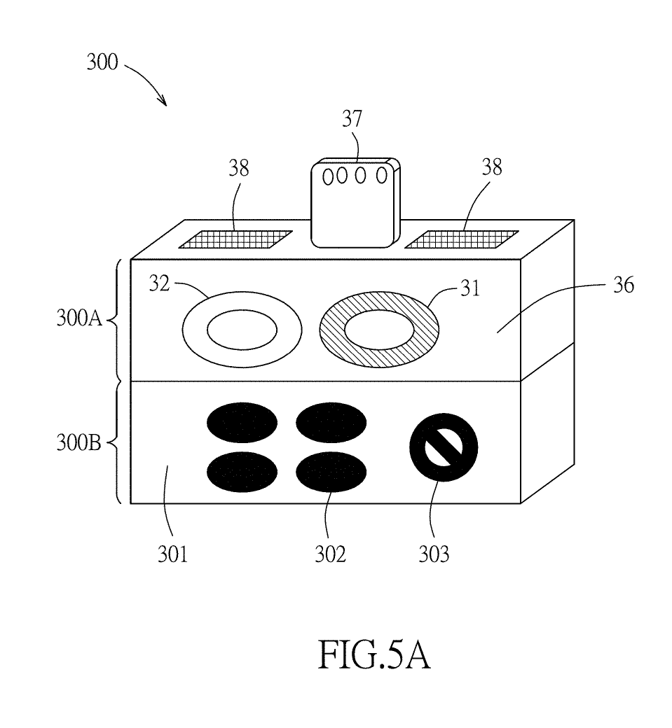

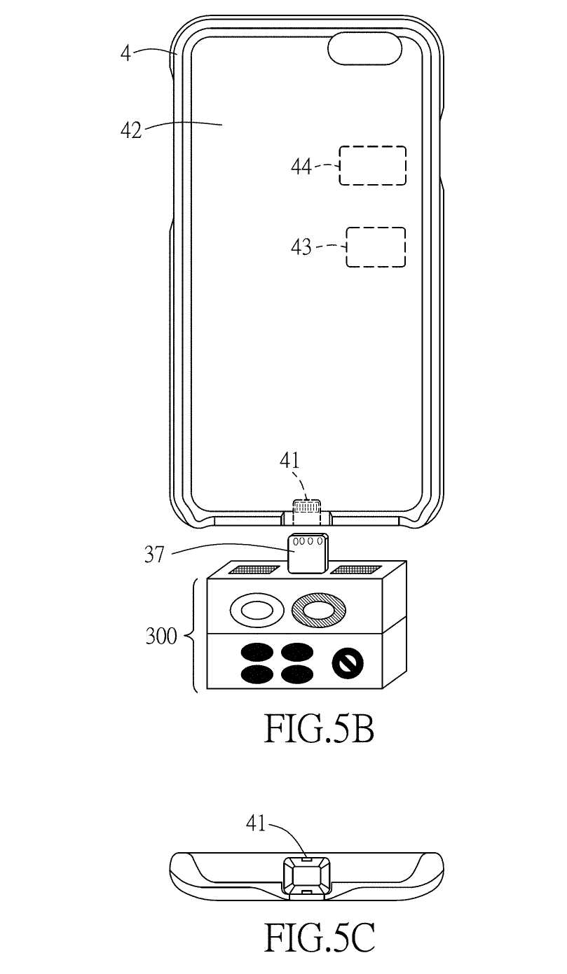

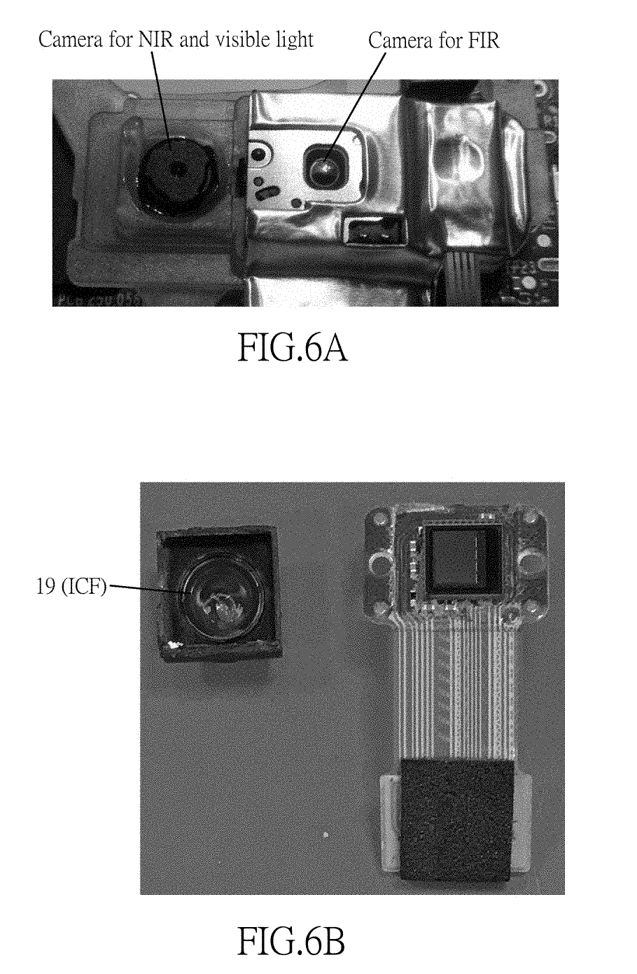

A relatively easy way to obtain the NIR thermal-imaging camera 300 of this embodiment is to acquire a conventional thermographic camera device 100 as shown in FIG. 1 that includes a camera housing 16 to serve as the camera housing 36 in this embodiment, and a camera module mounted to the camera housing 16. The camera module includes a first lens unit 11, a second lens unit 12, an FPA 13, an image sensor 14, and a processor 15 that respectively serve as the first lens unit 31, the second lens unit 32, the FPA 33, the image sensor 34 and the processor 35 in the NIR thermal-imaging camera 300 of this embodiment. The placement, characteristics and functions of the abovementioned components 11-15 are similar to those described for the components 31-35 of the NIR thermal-imaging camera 300 of this embodiment, and details thereof are not repeated herein for the sake of brevity. Differences between the conventional thermographic camera device 100 and the NIR thermal-imaging camera 300 of this embodiment reside in that the conventional thermographic camera device 100 further includes an ICF 19 (see FIG. 1) disposed between the second lens unit 12 and the image sensor 14 to receive the electromagnetic waves passing through the second lens unit 12, and to filter out NIR components from the electromagnetic waves received thereby, so that the electromagnetic waves received by the image sensor 14 (i.e., the electromagnetic waves passing through the ICF 19) has no NIR components or has the NIR components at negligibly low intensities. In order to make the NIR thermal-imaging camera 300 of this embodiment where the image sensor 34 can receive the NIR components of the electromagnetic waves passing through the second lens unit 32, the camera housing 16 is first removed from the camera module of the conventional thermographic camera device 100, and the ICF 19 is subsequently removed from the camera module (see FIGS. 6A and 6B). As a result, since nothing exists between the second lens unit 12 (32) and the image sensor 14 (34), the electromagnetic waves received by the image sensor 14 (34) is the same as the electromagnetic waves passing through the second lens unit 12 (32). However, merely removing the ICF 19 may induce an optical path difference which may result in issues on focusing. To compensate the optical path difference, a glass component 39 (see FIG. 4) that allows passage of electronic waves in the spectrum of near infrared and that has a shape and a thickness which are substantially identical to those of the ICF 19 can be mounted at where the ICF 19 was once located. In this embodiment, the glass component 39 is a BK-7 glass, but this disclosure is not limited in this respect.

Then, the camera housing 16 (36) may be mounted back to the camera module to form the camera unit 300A of the NIR thermal-imaging camera 300 of this embodiment, followed by attaching the NIR source unit 300B to the camera 300A, thereby completing building of the NIR thermal-imaging camera 300.

In one exemplary application, the NIR thermal-imaging camera 300 may be used in cooperation with an opaque separator that allows passage of electromagnetic waves falling within the spectrum of near infrared to observe a living target hidden from view (by the naked eye of a human being). For observing the living target, the opaque separator can be placed between the NIR thermal-imaging camera 300 and the living target, such that electromagnetic waves falling within the spectrum of near infrared and coming from the living target are received by the NIR thermal-imaging camera 300 after passing through the opaque separator, while the living target will not notice the presence of the NIR thermal-imaging camera 300.

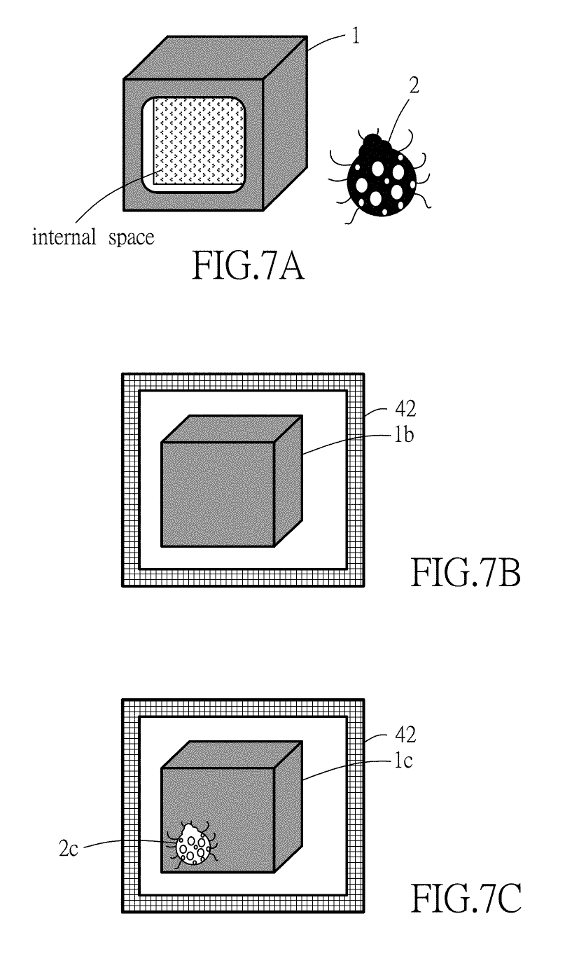

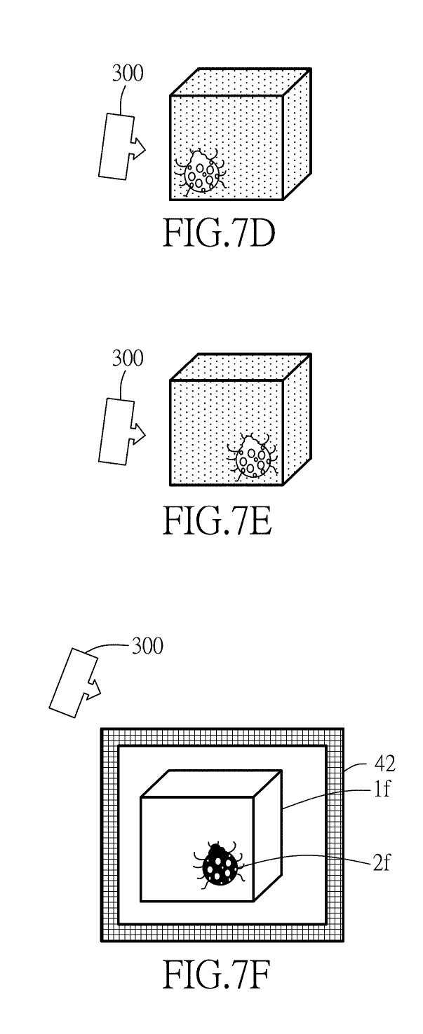

Specifically, the NIR thermal-imaging camera 300 and the opaque separator may be cooperatively used to observe a nocturnal/fossorial insect, animal or plant, or behaviors of an insect, an animal or a plant at night. In such implementation, as exemplified in FIG. 7A, an opaque box 1 is used to capture a living target 2 (e.g., a ladybug), so as to create a dark environment for deceiving the living target 2 in the opaque box 1 that it is nighttime. In practice, a ratio between the volume of living target and the volume of the opaque box 1 may range between 1:180 and 1:200, and it is noted that FIGS. 7A through 7F are not drawn to scale for the sake of clarity of illustration. In this case, a side portion of the opaque box 1 that is relatively proximate to the NIR thermal-imaging camera 300 serves as the opaque separator. In such application, when an ordinary camera that uses visible light to form images is used to face toward the opaque box 1 and to capture an image thereof, the resultant image can only include an appearance image 1b of the opaque box 1, as shown in FIG. 7B. When the conventional thermographic camera 100 (see FIG. 1) is used to capture an image of the opaque box 1, the resultant image may include an appearance image 1c of the opaque box 1 and an FIR thermal image 2c (see FIG. 7C) of the living target 2 when the living target 2 is near the side portion of the opaque box 1 (see FIG. 7D), because the living target 2 has a body temperature higher than a temperature of the opaque box 1. However, since the FIR thermal image is created based on the surface temperature of the to-be-captured object (i.e., the opaque box 1 in this case), the FIR thermal image of the living target 2 may be unclear in the resultant image, or even disappear from the resultant image when the “heat energy” (i.e., the heat radiation, or the FIR radiation) of the living target 2 cannot reach a lower portion of the side portion of the opaque box 1 at a sufficient level to result in a temperature difference that is distinguishable by the FPA on the surface of the side portion (e.g., the living target 2 is dead thus losing its body temperature, the living target 2 has left the opaque box 1, or the living target 2 is away from the side portion of the opaque box 1 as shown in FIG. 7E). When the thermal image of the living target 2 does not appear in the resultant image, the observer will not know what actually happens in the opaque box 1. The observer may need to move the opaque box 1 to confirm the situation (e.g., whether the living target 2 is still alive, or a position of the living target 2, etc.); however, this action may bother or scare the living target 2, and thus adversely affect the observation.

Referring to FIGS. 4 and 7F, the NIR thermal-imaging camera 300 may solve or alleviate the abovementioned problems that may also occur in images taken by the combination of the first lens unit 31 and the FPA 33 of the NIR thermal-imaging camera 300. The NIR component which is included in the sunlight and which passes through the opaque box 1 is reflected by the living target 2 to enter the NIR thermal-imaging camera 300 through the second lens unit 32, and reaches the image sensor 34 to form an NIR image that makes the details of the living target 2 clearer in the fusion image, as shown FIG. 7F, where the NIR image shows a transparent box 1f corresponding to the opaque box 1, and a living target image 2f. Accordingly, the observer may become aware of a current condition of the living target 2 when presented with the NIR image in the fusion image, and does not have to move the opaque box 1.

In a case that the sunlight is not strong enough, the observer may turn on the NIR source unit 300B to project NIR light toward the living target 2 through the opaque box 1, such that the second lens unit 32 receives the NIR light reflected by the living target 2 and passing through the side portion of the opaque box 1 (i.e., the opaque separator), thereby assisting in forming a clearer NIR image in the fusion image.

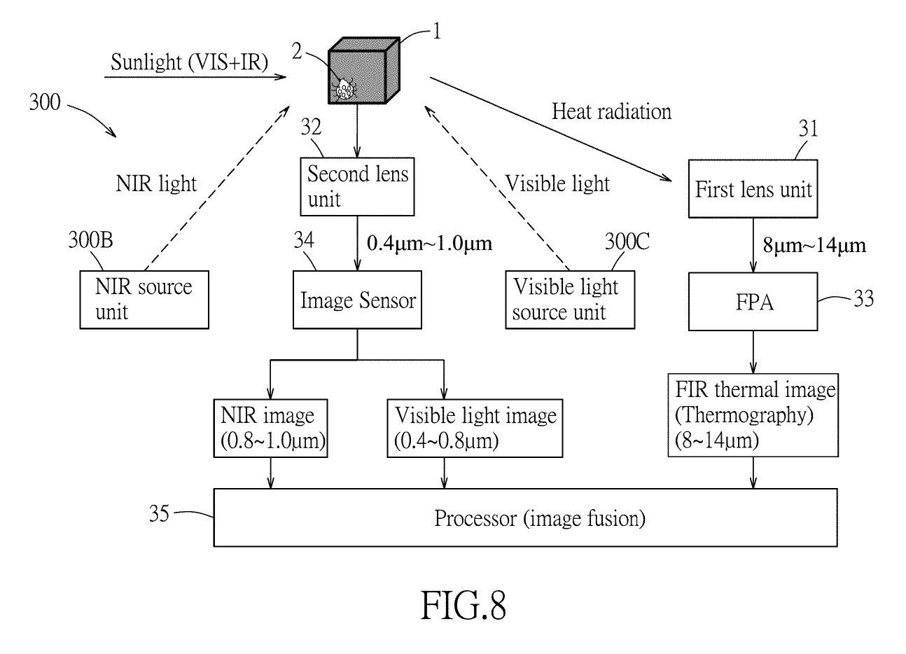

Referring to FIG. 8, the NIR thermal-imaging camera 300 may include both of the NIR source unit 300B and a visible light source unit 300C to respectively project NIR light and visible light toward the opaque box 1 while the living target 2 is in the opaque box 1. At the same time, the sunlight that includes visible light components (VIS) and NIR components (NIR) may also radiate on the opaque box 1. The electromagnetic waves in the spectrum of FIR may reach the FPA 33 through the first lens unit 31 by heat radiation, generating an FIR thermal image (thermography); the electromagnetic waves in the spectrum of NIR and visible light may reach the image sensor 34 through the second lens unit 32, respectively forming an NIR image and a visible light image. Then, the processor 35 performs image fusion on the FIR thermal image (thermography), the visible light image and the NIR image to generate a fusion image.

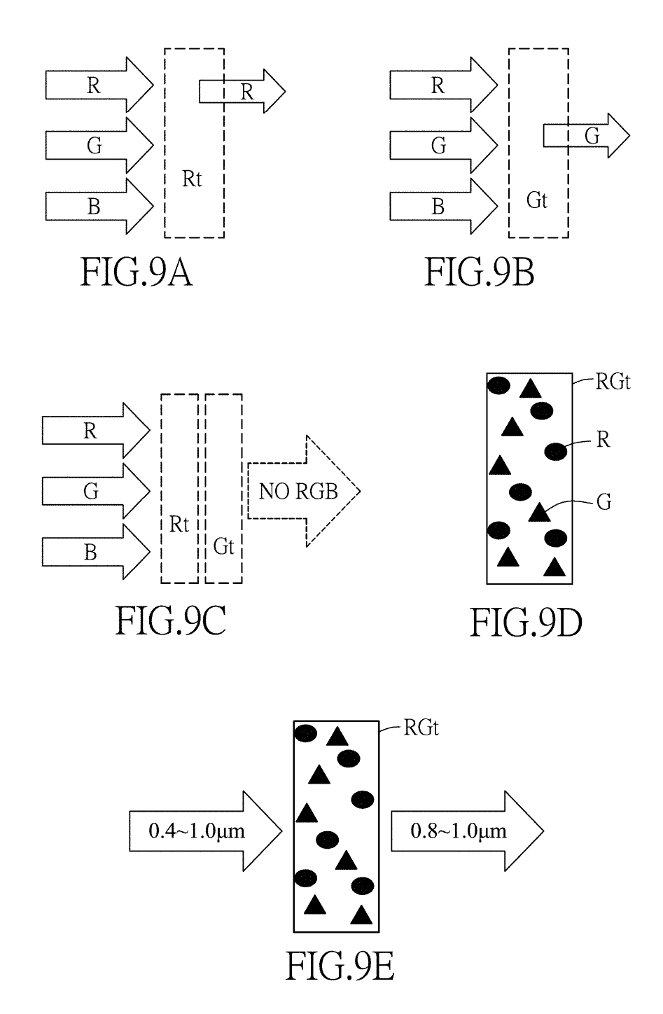

In one example, the opaque box 1 may be made of a transparent resin (e.g., polymethylmethacrylate (PMMA), polycarbonate (PC), etc.) in which a black material is added. The black material may be a mixture of at least two of three primary color masterbatches (i.e., red color masterbatch, green color masterbatch and blue color masterbatch). Referring to FIG. 9A, when the red color masterbatch is added into the transparent resin to form a red transparent plate (Rt), the red transparent plate (Rt) only allows passage of red light, while blue light and green light are absorbed thereby. Similarly, referring to FIG. 9B, when the green color masterbatch is added into the transparent resin to form a green transparent plate (Gt), the green transparent plate (Gt) only allows passage of green light, while blue light and red light are absorbed thereby. Accordingly, referring to FIG. 9C, when the red transparent plate (Rt) and the green transparent plate (Gt) are used at the same time, almost all of the red light, green light and blue light are absorbed by the combination of the red transparent plate (Rt) and the green transparent plate (Gt), and thus the red transparent plate (Rt) and the green transparent plate (Gt) are capable of serving as an opaque material suitable for making the opaque separator. Referring to FIG. 9D, when two or more of the primary color masterbatches (e.g., the red color masterbatch (R) and the green color masterbatch (G)) are added into the transparent resin to form an opaque separator (e.g., the plate (RGt) in FIGS. 9D and 9E), and the opaque separator receives electromagnetic waves with wavelengths ranging between 0.4 μm and 1 μm, a part of the electromagnetic waves with wavelengths ranging between 0.4 μm and 0.8 μm will be absorbed by the opaque separator, and only the remaining part of the electromagnetic wave with wavelengths ranging between 0.8 μm and 1 μm can pass through the opaque separator, as shown in FIG. 9E. Reference may be made to Taiwanese Patent No. I328593 for details of producing the opaque separator using the masterbatches. Accordingly, the opaque separator will be nearly transparent in the NIR image. In one example, the opaque separator is made of a mixture of carbon black and a transparent resin, and reference may be made to Taiwanese Patent No. 1328593 for details of producing such an opaque separator. In one example, the opaque separator includes a transparent resin substrate, and at least one silicon dioxide thin film layer and at least one titanium dioxide thin file layer that are alternately formed/coated on the transparent resin substrate, and reference may be made to Taiwanese Patent Nos. M364878 and M346031 for details of producing such an opaque separator. In such example, the coatings allow passage of the NIR light within a specific wavelength range, and reflect visible light.

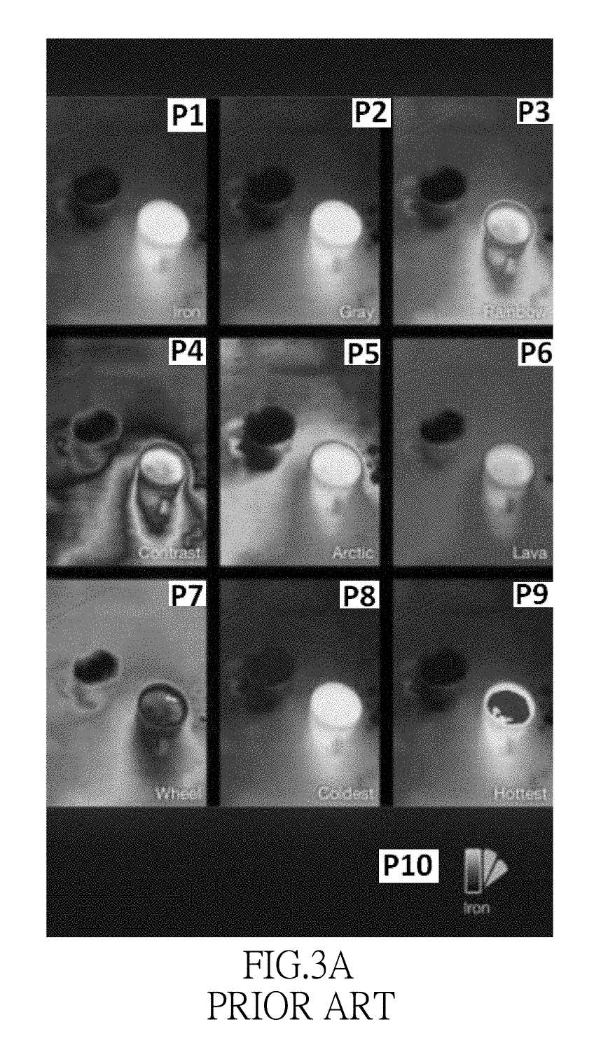

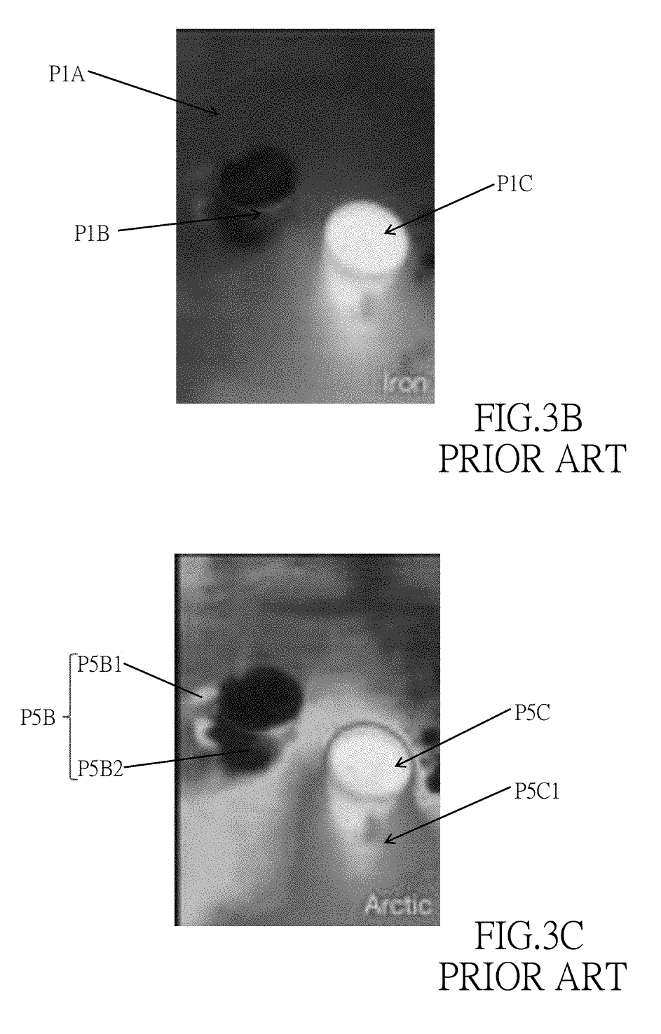

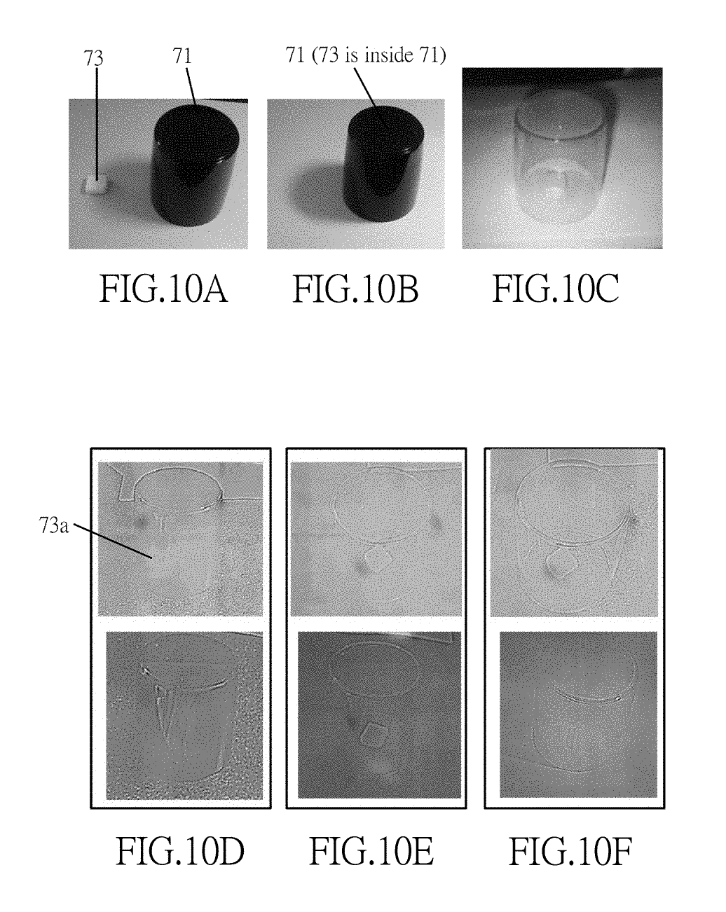

Referring to FIGS. 5A and 10A-10F, a black cup 71 and a white block 73 (see FIG. 10A) are used to verify the imaging effect of the NIR thermal-imaging camera 300. The black cup 71 is used to cover the white block 73 on a tabletop (see FIG. 10B), thereby forming a target object, and the NIR thermal-imaging camera 300 is used to capture images of the target object. FIG. 10C shows a pure NIR image of the target object captured by the NIR thermal-imaging camera 300 with the NIR source unit 300B turned on to enhance clarity of the NIR image. It can be seen from FIG. 10C that, in the NIR image, the black cup 71 becomes transparent, and the edges of both the black cup 71 and the white block 73 are clear. FIG. 10D includes two fusion images that are obtained using the conventional thermographic camera 100 (see FIG. 1), where the upper image and the lower image are respectively generated using the pseudo color modes P1, P2, which are exemplified in FIG. 3A. In FIG. 10D, the appearance of the white block 73, such as a shape of the white block 73, can hardly be discerned, and only some temperature difference (referenced by a numeral 73a), which may result from a temperature transfer onto the target object from fingers of an operator who placed the white block 73 in the black cup 71, can be seen. FIG. 10E includes two fusion images that are captured using the NIR thermal-imaging camera 300 (see FIG. 5A) with the NIR source unit 300B turned off, where the upper image and the lower image are respectively generated using the pseudo color modes P1, P2. It is apparent that the image of the white block 73 in FIG. 10E is clearer in comparison to FIG. 10D. FIG. 10F includes two fusion images that are captured using the NIR thermal-imaging camera 300 with the NIR source unit 300B turned on, where the upper image and the lower image are respectively generated using the pseudo color modes P1, P2. In FIG. 10F, the contours of both the black cup 71 and the white block 73 are even clearer compared to FIG. 10E.

In another exemplary application, the NIR thermal-imaging camera 300 may be used in an international airport at immigration inspection, so as to check whether a traveler is getting a fever while the facial features of the traveler can be identified at the same time. Although some travelers may wear sunglasses, the electromagnetic waves of NIR that are reflected by the traveler can still pass through the sunglasses, so that the image taken by the NIR thermal-imaging camera 300 can still show the facial features of the traveler.

In an exemplary application of security control, the NIR thermal-imaging camera 300 may be used to detect dangerous articles which may be hidden in an opaque container (e.g., an opaque bag, an opaque box, etc.) and which may have a temperature different from the room temperature. By using a conventional thermography camera or the conventional thermographic camera 100, the captured image may only show that there is an object having a different temperature in the opaque container. However, images taken by the NIR thermal-imaging camera 300 of this disclosure may show the contours or edges of the object therein, so that the object may be identified.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A near-infrared thermal-imaging camera comprising:
a first lens unit disposed to receive electromagnetic waves from a target scene, and allowing passage of at least a portion of the electromagnetic waves received thereby that falls within a spectrum of far infrared (FIR), the at least a portion of the electromagnetic waves passing through said first lens unit representing a first image;
a second lens unit disposed to receive electromagnetic waves substantially from the target scene, and allowing passage of at least a portion of the electromagnetic waves received thereby that falls within a spectrum of near infrared (NIR), which ranges between 0.4 μm and 1 μm in terms of wavelength, the at least a portion of the electromagnetic waves passing through said second lens unit representing a second image, wherein the electromagnetic waves passing through said first lens unit and the electromagnetic waves passing through said second lens unit are independent from each other;
an NIR source unit configured to project NIR light that has a wavelength falling within the spectrum of near infrared toward the target scene, such that the NIR light projected thereby is reflected to said second lens unit by an object disposed in the target scene; and
a processor configured to perform image fusion on the first and second images to generate a fusion image.

2. The near-infrared thermal-imaging camera of claim 1, further comprising:
a focal plane array sensitive at least in the spectrum of far infrared, disposed to receive the electromagnetic waves passing through said first lens unit, and configured to convert the electromagnetic waves received thereby into image signals that represent the first image; and
an image sensor sensitive at least in the spectrum of near infrared, disposed to receive the electromagnetic waves passing through said second lens unit, and configured to convert the electromagnetic waves received thereby into image signals that represent the second image, a portion of the electromagnetic waves received by said image sensor that falls within the spectrum of near infrared being substantially equal to the portion of the electromagnetic waves that falls within the spectrum of near infrared and that passes through said second lens unit in terms of intensity;
wherein said processor is coupled to said focal plane array and said image sensor for receiving the image signals therefrom for performing the image fusion.

3. The near-infrared thermal-imaging camera of claim 1, wherein the spectrum of far infrared ranges between 8 μm and 14 μm in terms of wavelength.

4. The near-infrared thermal-imaging camera of claim 1, wherein the wavelength of the NIR light projected by said NIR source unit ranges between 0.8 μm and 1 μm.

5. The near-infrared thermal-imaging camera of claim 1, wherein said NIR source unit includes an infrared light emitting diode module having an output power of between 1 watt and 5 watts.

6. A system for observing a living target hidden from view, comprising:
a near-infrared thermal-imaging camera of claim 1 so disposed that the living target is part of the target scene with respect to said near-infrared thermal-imaging camera; and
an opaque separator that allows passage of electromagnetic waves falling within the spectrum of near infrared, said opaque separator to be disposed between said near-infrared thermal-imaging camera and the living target such that electromagnetic waves falling within the spectrum of near infrared and coming from the living target are received by said second lens unit of said near-infrared thermal-imaging camera after passing through said opaque separator.

7. The system of claim 6, wherein said opaque separator is a part of an opaque box that is configured to have the living target captured inside.

8. The system of claim 6, wherein said opaque separator is made of a transparent resin in which a black material is added, wherein the black material is a mixture of at least two of the following: red color masterbatch, green color masterbatch and blue color masterbatch.

9. The system of claim 6, wherein said opaque separator is made of a mixture of carbon black and a transparent resin.

10. The system of claim 6, wherein said opaque separator includes a transparent resin substrate, and at least one silicon dioxide layer and at least one titanium dioxide layer that are alternately formed on said transparent resin substrate.
